(19) United States
(12) Patent Application Publication
(10) Pub. No.: US 2018/0260838 A1
(43) Pub. Date: Sep. 13, 2018

(54) SYSTEM AND METHODS FOR FACILITATING A PURCHASE

(71) Applicants: William R. New, Fayetteville, GA (US); Charles A. Soeros, Roswell, GA (US); James E. Carey, III, Lakeland, FL (US); Craig Moodie, Asheville, NC (US)

(72) Inventors: William R. New, Fayetteville, GA (US); Charles A. Soeros, Roswell, GA (US); James E. Carey, III, Lakeland, FL (US); Craig Moodie, Asheville, NC (US)

(21) Appl. No.: 15/451,927

(22) Filed: Mar. 7, 2017

(51) Int. Cl. G06Q 30/02; G06Q 30/06; G06F 17/30

(52) U.S. Cl. CPC G06Q 30/0239; G06Q 30/0625; G06F 17/30312; G06Q 30/0641

(57) ABSTRACT

The present disclosure is related to a method that includes providing an application on a user device to enable an end-user to register a delivery device. The delivery device is associated with a discount value and at least one distribution entity. The method further includes receiving a request from the user device, the request being indicative of a purchase of an item from a seller. The method also includes determining a discounted price for the item, wherein the discounted price is lesser than a listed price and greater than a wholesale price. The method further includes enabling the end-user to purchase the item at the discounted price. The method also includes determining a first value and a second value, wherein the first value is transferred to an account of the at least one distribution entity and the second value is transferred to an account of the seller.

### BACKGROUND OF INVENTION

The disclosed subject matter relates to purchase of goods and services, and more specifically to systems and methods for enabling purchase of goods and services through a user interface.

Electronic commerce, commonly known as e-commerce, is the facilitation of trading in products or services using computer networks, such as the Internet or online social networks. Electronic commerce draws on various technologies, such as mobile commerce, electronic funds transfer, Internet marketing, online transaction processing, electronic data interchange (EDI), and automated data collection systems. Modern electronic commerce typically uses websites or web-based applications for carrying out transactions.

However, e-commerce services provide purchase of goods or services at a fixed amount. Typically, users can only purchase services or goods such as, but not limited to, hotel bookings, clothing, and electronic devices, at prices shown at the respective web sites or applications. There is no scope of reduction in the prices listed by the sellers.

### SUMMARY OF INVENTION

Some related arts provide various processes for web-based selling and purchasing of goods and services. Service providers, enabling such web-based transactions, typically have an online storefront. These service providers post the products, that are available for sale online, and provide the terms of sale, including the price, and customers place purchase orders to purchase such products upon accepting the terms of sale. However, the prices are non-negotiable for the customers in such online purchases.

Some related arts offer a loyalty program that provides rewards to customers who frequently make purchases. Loyalty program may give a customer advanced access to new products, sales coupons or free merchandise. Customers typically register their personal information with the company and are given a unique identifier, such as a numerical ID or a membership card, and use that identifier when making a purchase. A specific number of reward points are given to the customer after a purchase, the reward points being added to the membership card. However, the reward points for a purchase can only be used on the next purchase as a discount based on the points or value stored on the membership card.

It may therefore be beneficial to provide systems and methods to facilitate sale and purchase of items to provide discounts to the end-user while making the purchase. Specifically, it may be beneficial to generate one or more delivery devices, such as discount cards or coupons, and to distribute the delivery devices to the end-users to increase usage or sale of an item. It may also be beneficial to enable the end-users to access information regarding the purchase of various items by a single registration step.

It may further be beneficial to provide systems and methods to provide profit for both the seller of the item, provider of the delivery device and/or the distributor of the delivery device based on an unused discount value present on the delivery device.

It may further be beneficial to provide a single platform for multiple sellers to offer the sale of multiple items and for the end-users to make one or more purchases from the sellers. It may further be beneficial for the end-users to compare prices for one or more items and to choose the best suitable price for a purchase.

It may also be beneficial to enable the end-users to purchase different types and/or number of items from multiple sellers at discounted prices using a single delivery device at the time of each purchase.

Some embodiments are directed to systems and methods that receive a query from a user device indicative of a purchase, transmit the query to a server, and display results from the server on the user device, the results including a list of items from multiple sellers. A listed price and a discounted price is displayed for each item. Upon receiving an input from the end-user regarding purchase of an item, the systems and methods enable the end-user to purchase the item at the discounted price based on a discount value provided by a deliver device. Further, an unused discount value, that is equal to a difference between a wholesale price and the discounted price of the item, is distributed among the seller, a provider of the delivery device and/or a distributor of the delivery device in the form of an equivalent currency denomination.

Some embodiments are directed to a method that includes providing an application on a user device to enable an end-user to register a delivery device, wherein the delivery device is associated with a discount value and at least one distribution entity. The method further includes, generating, by the application, a personalized user interface, wherein the personalized user interface displays the discount value to the end-user. The method further includes, receiving, by a server, a request from the user device over a network, wherein the request is indicative of a purchase of at least one item from a seller, the at least one item having a wholesale price and a listed price greater than the wholesale price. The method further includes, determining, by the server, a discounted price for the at least one item, wherein the discounted price is lesser than the listed price and greater or lesser than the wholesale price, and wherein the difference between the listed price and the discounted price is less than or equal to the discount value. The method further includes enabling, through the application, the end-user to purchase the at least one item at the discounted price. The method further includes, updating, by the server, the discount value associated with the delivery device based on a difference between the listed price and the discounted price, wherein the updated discount value is displayed through the personalized user interface. The method further includes, determining, by the server, a first value and a second value based on a difference between the discounted price and the wholesale price, and a distribution ratio corresponding to the seller and the at least one distribution entity, wherein a sum of the first value and the second value is equal to the difference between the discounted price and the wholesale price, and wherein when the first value is greater than zero is transferred to an account of the at least one distribution entity and when the second value is greater than zero is transferred to an account of the seller.

Some embodiments are directed to a method that includes providing an application on a user device to enable an end-user to register a delivery device, wherein the delivery device is associated with a discount value and at least one distribution entity. The method includes, receiving, by the server, registration details from the user device over a network, wherein the registration details comprise a unique identification number, and wherein the delivery device is activated upon registration by the end-user. The method further includes, generating, by the application, a personalized user interface, wherein the personalized user interface displays the discount value to the end-user. The method further includes, receiving, by a server, a request from the user device over a network, wherein the request is indicative of a purchase of at least one item from a seller, the at least one item having a wholesale price and a listed price greater than the wholesale price. The method further includes, determining, by the server, a discounted price for the at least one item, wherein the discounted price is lesser than the listed price and in some cases greater or lesser than the wholesale price, and wherein the difference between the listed price and the discounted price is less than or equal to the discount value. The method further includes, enabling, through the application, the end-user to purchase the at least one item at the discounted price. The method further includes, updating, by the server, the discount value associated with the delivery device based on a difference between the listed price and the discounted price, wherein the updated discount value is displayed through the personalized user interface. The method further includes, determining, by the server, a first value and a second value based on a difference between the discounted price and the wholesale price, and a distribution ratio corresponding to the seller and the at least one distribution entity, wherein a sum of the first value and the second value is equal to the difference between the discounted price and the wholesale price, and wherein when the first value is greater than zero is transferred to an account of the at least one distribution entity and when the second value is greater than zero is transferred to an account of the seller.

Yet other embodiments are directed to a system including a user device comprising an application installed thereon, wherein the application is configured to enable an end-user to register a delivery device, wherein the delivery device is associated with a discount value and at least one distribution entity. The application is further configured to display, through a personalized user interface, the discount value to the end-user. The system also includes a server disposed in communication with the user device over a network, wherein the server is configured to receive a request from the user device over a network, wherein the request is indicative of a purchase of at least one item from a seller, the at least one item having a wholesale price and a listed price greater than the wholesale price. The server is further configured to enable, through the application, the end-user to purchase the at least one item at a discounted price, wherein the discounted price is lesser than the listed price and greater or lesser than the wholesale price, and wherein the difference between the listed price and the discounted price is less than or equal to the discount value. The server is further configured to update the discount value associated with the delivery device based on a difference between the listed price and the discounted price, wherein the updated discount value is displayed through the personalized user interface. The server is further configured to determine a first value and a second value based on a difference between the discounted price and the wholesale price, and a distribution ratio corresponding to the seller and the at least one distribution entity, wherein a sum of the first value and the second value is equal to the difference between the discounted price and the wholesale price, and wherein when the first value is greater than zero is transferred to an account of the at least one distribution entity and when the second value is greater than zero is transferred to an account of the seller.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrate an exemplary system for facilitating a purchase process in accordance with the disclosed subject matter.

FIG. 2 illustrates an exemplary embodiment of a delivery device in accordance with the disclosed subject matter.

FIGS. 3A, 3B, 3C, 3D and 3E illustrate various embodiments of a database entry in accordance with the disclosed subject matter.

FIGS. 4A, 4B, 4C, 4D and 4E illustrate various embodiments of a user interface shown on a user device in accordance with the disclosed subject matter.

FIG. 5 is a flowchart of an exemplary method for facilitating a purchase.

FIG. 6 is a flowchart of another exemplary method for facilitating a purchase.

FIG. 7 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

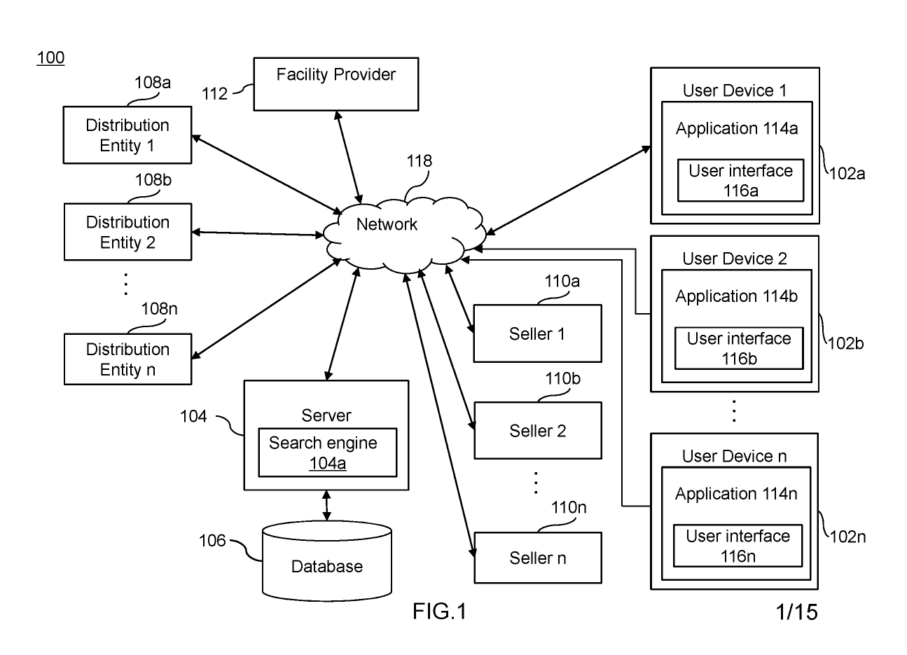

FIG. 1 is an illustration of a system 100 in accordance with the disclosed subject matter. The system 100 facilitates sale and purchase processes. Specifically, the system 100 facilitates exchange of data between one or more user devices 102a to 102n (hereinafter collectively referred to as “the user device(s) 102”) and a server 104. The system 100 is a transaction system operated by the user device 102, the server 104, one or more distribution entities 108a to 108n (hereinafter collectively referred to as “the distribution entity(ies) 108”), one or more sellers 110a to 110n (hereinafter collectively referred to as “the seller(s) 110”) and one or more facility providers 112. The system 100 implements transaction for purchase of items, such as goods or services. The goods can be, but not restricted to, electronic devices, apparels, furniture and the like. Further, the services can be, but not restricted to, a hotel booking, a vacation package, and the like.

The server 104 connects to a database 106. The database 106 includes a distributor database (not shown) and a seller database (not shown). The database 106 maintains records pertaining to the sellers 110, the distribution entities 108, delivery devices (not shown in FIG. 1) and the user devices 102. The delivery devices may be any discount card, coupon, online account and the like, that enable discount options pertaining to specific transactions for an end-user. The database 106 can be, but not restricted to, a relational database, an object-relational database, and the like. The database 106 may organize data into one or more tables of columns and rows with a key identifying a row and/or column in each table. The keys for each row and/or column may be used to define logical connections (called relationships) among the tables. The database 106 maintains records to store details of one or more delivery devices, the seller or sellers 110 related to the one or more delivery devices, the items provided by the sellers 110 for sale to the end-users, details of every purchase made by a user device 102, wholesale prices of the items, listed prices of the items, discounted prices of the items and a discount for every item. The discount for every item can be a forecasted value by the server 104. In some embodiments, the discount can also be based on a level of membership of the end-user. For example, the end-user with five years of membership with the facility provider 112 may receive more discount on a purchase than an end-user with two years of membership with the facility provider 112. As such, the server 104 may vary a distribution ratio corresponding to each set of one seller 110, one or more distribution entities 108 distributing a given delivery device, and the facility provider 112.

In an embodiment, the server 104 may dynamically vary the distribution ratio of an unused profit margin (interchangeably referred to as “the profit margin”) based on parameters including, but not limited to, a minimum threshold profit margin of the seller, a commission percentage for the one or more distribution entities 108 and a profit percentage of the facility provider 112. The minimum threshold profit margin is a minimum percentage of profit for one or more items offered for sale by the seller 110. The minimum percentage of profit may be based on the wholesale price of the item. The commission percentage may be a percentage of the wholesale price, the discounted price or the profit margin that has to be paid to the one or more distribution entities 108. Similarly, the profit percentage of the facility provider 112 may be a percentage of the wholesale price, the discounted price or the profit margin that has to be paid to the facility provider 112.

In some embodiments, the server 104 includes a plurality of different functions for updating the database 106 with new data. The server 104 can obtain up-to-date information from the sellers 110 regarding the items that the sellers 110 currently have for sale. The server 104 can further provide a capability for authenticating the user devices 102 of the one or more end-users and providing access only to authenticated users. The server 104 can also determine whether the customer search specifications can be met by an existing seller 110, or whether an alternative seller 110 has to be suggested. In some embodiments, the server 104 can store the distribution ratio(s) corresponding to each of the sellers 110, each of the distribution entities 108 and the facility provider 112 in the database 106. The server 104 can record in the database 106, the transactions as they occur, and structure transactions into a purchase order format. The server 104 can track the flow of profit (income) to document the end-user purchases, margin calculations, and payments made to the seller 110, the one or more distribution entities 108 and the facility provider 112. In some embodiments, the server 104 can track shipping methods used for each purchase, and record shipment data to verify release of items by the sellers 110 and receipt of the items by the end-users.

The server 104 enables the system 100 to receive up-to-date item information of the sellers 110 and the items provided by the seller 110. The information regarding the items on sale is organized and stored in the database 106, which is periodically updated to reflect new information. In one embodiment, database 106 is updated with seller information in real-time. In another embodiment, database 106 is periodically updated with information provided by the sellers 110. The distribution entity 108, may also enter various details using a password-protected web forms. Such details may include commission percentage for the distribution entity 108, associated delivery devices, and the like. The details entered by the distribution entity 108 can be stored in the database 106.

Further, the database 106 stores details of all the items on sale by a particular seller 110. Details of the items can include, but not restricted to, wholesale price, listed price and the discount on the item. In some embodiments, the seller 110 can provide the minimum threshold profit margin and the server 104 can dynamically deduce a discount for the item depending upon the minimum threshold profit margin provided by the seller 110 and a discount value stored in the delivery device. The discount value may correspond to a number of points or a currency denomination. The discount for the item may be lesser than or equal to the discount value stored in the delivery device. The server 104 can further dynamically deduce a distribution ratio for the one or more distribution entities, the seller 110 and the facility provider 112. The distribution ratio may determine a distribution of the unused profit margin between the one or more distribution entities, the seller 110 and/or the facility provider 112.

The minimum threshold profit margin means that the server 104 distributes the profit margin in a way that the profit percentage for the seller is greater than or equal to the minimum threshold profit margin and the rest of the profit margin can be dynamically divided by the server 104 between the facility provider 112, and the distribution entity 108. The distribution ratio is the ratio of the distribution of the profit margin between the facility provider 112, the seller 110 and the distribution entity 108 of a particular delivery device on the purchase of an item by the end-user using that particular delivery device. The end-user makes a purchase with a discounted price which is lesser than the listed price of the item and greater or lesser than the wholesale price of the item. The profit margin may be equal to a difference between the discounted price and the wholesale price, and is distributed between the facility provider 112, the seller 110 and the distribution entity 108 according to the distribution ratio of the profit margin. In an embodiment, the distribution ratio of the profit margin between the facility provider 112, the seller 110 and the distribution entity 108 can be 1:1:1, or any variation of ratios in this format. In some other embodiments, the facility provider 112 can be the seller 110 and the distribution ratio can be divided between the facility provider and the distribution entity 108 as 1:1, or any variation of ratios in this format. In some other embodiments, the facility provider 112 can be the entity to distribute the delivery device to the end-users, then the facility provider 112 gains the whole profit margin. In yet other embodiments, the seller 110 may not receive any of the profit margin, and the profit margin is divided wholly between the facility provider 112 and the seller 110 based on the distribution ratio. The distribution ratio(s) for all aforementioned cases may be stored in the database 106.

In an embodiment, the amount corresponding to the facility provider 112, the seller 110 and/or the distribution entity 108 as per the distribution ratio is added to respective accounts of the facility provider 112, the seller 110 and the distribution entity 108 in the form of a financial instrument or a currency denomination. The account details of the sellers 110 are stored at the seller database, while the account details of the distribution entities 108 are stored at the distribution database. The database 106 may be dynamically updated with every transaction made by the end-users and/or any information changes made by the end-users, the sellers 110 and the distribution entities 108.

In an embodiment, the facility provider 112 can be, but not restricted to, a person, a group of persons, a company, and the like. The terms “facility provider” and “facility company” are used interchangeably to refer to the party that is responsible for manufacturing or generating a delivery device. The delivery device can be, but not restricted to cards, coupons, online accounts and the like. The facility provider 112 associates a discount value to the delivery device. The discount value can be different for different delivery devices depending upon the type of the delivery device.

In some embodiments, the facility provider 112 provides the discount values on the delivery devices to incentivize people to purchase the products that the sellers 110 are offering for sale. For example, a car dealer may offer a free $100 Hotel Card to incentivize people to test drive vehicles. The $100 Hotel Card can be used to book hotels and avail a discount that is less than or equal to $100.

The facility provider 112 further maintains information regarding every delivery device in the database 106 through the network 118. The facility provider 112 further generates a unique identification number corresponding to each delivery device having a stored discount value and stores the unique identification numbers of the one or more delivery devices in the database 106. In an embodiment, the facility provider 112 issues the one or more delivery devices to the one or more distribution entities 108 for the distribution of the delivery devices to the end-users. In an embodiment, the facility provider 112, through the server 104, may maintain a record in the database 106 corresponding to each delivery device with its respective one or more distribution entities 108, the unique identification number of each delivery device, type of the delivery device, the discount value stored on the delivery device and various details of the end-user identification of the delivery device.

The facility provider 112 is communicably coupled to the sellers 110 via the network 118. The facility provider 112 can associate various goods or services (collectively referred to as “items”), offered by the sellers 110, with the delivery device. The sellers 110 can provide various items for sale, such as hotel rooms for booking, electronic devices, apparels, and so forth. Upon purchase of an item by an end-user of one of the delivery devices, the server 104 can provide a percentage of the profit margin to the corresponding seller 110 of the item. Each of the sellers 110 can set a minimum threshold profit margin on every item that the seller 110 provides for sale through the one or more delivery devices. The minimum threshold profit margin can be the minimum percentage of the profit margin or the wholesale price that the seller 110 intends to receive as income from every purchase of the corresponding item.

In some embodiments, each of the sellers 110 can be, but not restricted to, a person, a group of persons, a company, and so forth, that offers the one or more items for sale to the end-users. The items can be goods or services, such as, but not restricted to, electronic devices, apparels, booking of hotel rooms, and the like. The sellers 110 can be interchangeably referred to as “the retailers”, “the merchants”, “the vendors”, and so forth.

Each of the end-users can be a person, a group of persons, a company, or the like. Further, the end-users can be interchangeably referred to as “the consumers”, “the buyers”, “the shoppers”, “the purchasers” and so forth.

Each of the distribution entities 108 can be a person, a group of persons, a company, or the like. Further, each of the distribution entities 108 can be interchangeably referred to as “the brokers”, “the dealers”, and so forth.

Further, the facility provider 112 is communicably coupled to the distribution entities 108 via the network 118. Each of the distribution entities 108 is responsible for distributing the delivery devices, received from the facility provider 112, to the customers or end-users. In an embodiment, more than one distribution entity 108 can be responsible for distributing a single delivery device to the end-user. In such cases, a portion of the profit margin can be appropriately distributed among the multiple distribution entities 108 corresponding to the given delivery device upon purchase of an item by the end-user. The end-user can operate the delivery device to save an amount of money on every purchases made using the respective delivery device by using the discount value stored on the delivery device while making a transaction. In an embodiment, if the end-user makes a purchase using the delivery device provided by the distribution entity 108, then the facility provider 112, the seller 110 and/or the distribution entity 108 gains a percentage of the profit margin on that item.

In some embodiments of the present subject matter, the end-users operate the one or more user devices 102 to perform processes related to purchase of the items. The user devices 102 of the end-users is communicably coupled to the server 104 via the network 118. The user devices 102 can include any type of device including desktop computers, portable computers, smartphones, tablet computers, wearable devices, and the like. Each of the user devices 102 may also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

In an embodiment, the user device 102 has an application 114a to 114n (hereinafter collectively referred to as “the application 114”) to enable an end-user to interact with the server 104 by generating a personalized user interface 116a to 116n (hereinafter collectively or individually referred to as “the user interface 116”).

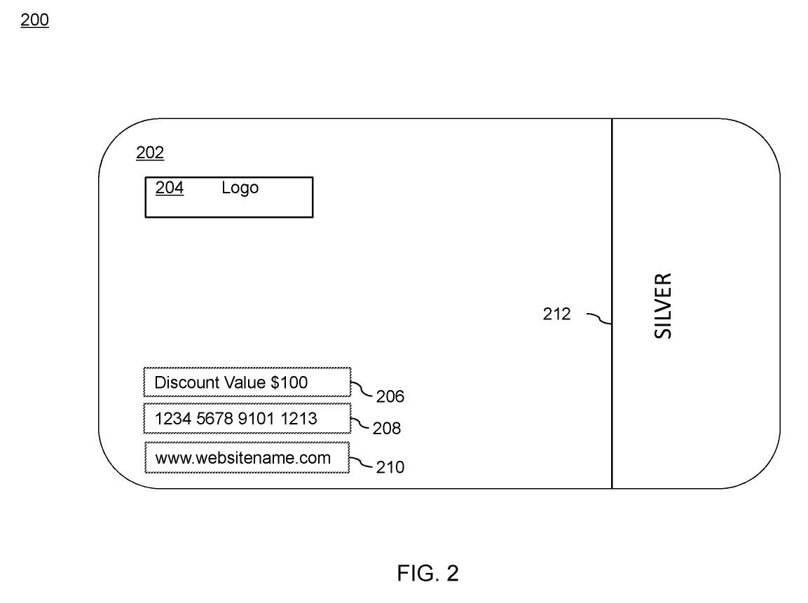

FIG. 2 illustrates a delivery device 202 according to an embodiment of the present disclosure. The delivery devices 202 can be, but not restricted to, cards, coupons, online accounts and the like. An exterior surface of the delivery device 202 can display a logo 204, a discount value 206 stored on the respective delivery device 202, a delivery device number 208, a name 210 of an official website of the facility provider 112, a type 212 of the delivery device, etc. Further, the logo 204 can include, but not restricted to, a name, a number, a graphical image, or a combination thereof, corresponding to the facility provider 112. In an embodiment, the delivery device number 208 can be a unique identification number provided by the facility provider 112 for, tracking, registering, and providing a unique identity to the delivery device 202. The unique identification number can be a number, an alphanumeric string, or the like. However, in other embodiments, the delivery device number 208 may be any other number distinct from the unique identification number. The type 212 of the delivery device 202 can be, but not restricted to, silver, gold, platinum, and so forth. The type 212 of the delivery device may represent the type of membership of the end-user, a maximum discount value or currency denomination of the delivery device 202, etc. Embodiments are also intended to include or otherwise cover any other type of delivery device. The delivery device 202 is merely provided for exemplary purposes, and the various inventive aspects are intended to be applied to any type of delivery device. In some embodiments, the end-user may be required to activate the delivery device 202 before purchasing an item at a discounted price.

The delivery device 202 may be a physical card or any portable device that can also include a magnetic strip, a biometric chip, an RFID (Radio Frequency Identification) tag, or other types of Near Field Communication (NFC) chip, and.or indicia for enabling unique identification of the delivery device 202. In some other embodiments, the delivery device can be a virtual card shared with the end-user using electronic means. In such a case, the end-user can make transactions using at least the unique identification number associated with the delivery device 202. The virtual card can also be an account with the required information of the discount value 206 stored on the account. The account may have a set of authentication information for the corresponding end-user to securely login and access the discount value 206 for making transactions.

As and when the delivery device 202 is activated, the server 104 determines a discounted price for the item, based on the discount value 206. The determined discounted price is lesser than the listed price and greater or lesser than the wholesale price for the item. The discount value 206 is greater than or equal to the difference between the listed price and the discounted price. The discounted price is updated by the server 104 and is displayed to the end-user via the user interface 116 displayed on the user device 102.

The end-user can register the delivery device 202 via the application 114 on the user device 102. The delivery device 202 is associated with the discount value 206 (also referred to in this disclosure as “DV”) and at least one end-user operating one of the user devices 102. In an embodiment, the end-user can follow a registration process on the user interface 116 for the activation of the delivery device 202 prior to using the delivery device 202. After the completion of registration process, the server 104 activates the respective delivery device 202 by making required changes in the database 106 that is connected to the server 104. Once the delivery device 202 is activated, the end-user can access the server 104 to choose and purchase one of the many items provided by the server 104 at a discounted price with the respective delivery device 202.

The application 114 can be a web application, a web site, a software package etc. The application 114 may be installed on the user device 102. Further, the application 114 may include a set of computer readable instructions or code, that on execution by a processor of the user device 102, enables the user device 102 to perform various functions. For example, the end-user can use the application 114 to book a hotel room using the discount value 206 available on the delivery device at a price lesser than the listed price. The discounted price is greater than the wholesale price and lower than the listed price of the item to be purchased.

The server 104 determines a first value and a second value based on a difference between the discounted price and the wholesale price and a distribution ratio corresponding to the seller 110 and at least one distribution entity 108. The sum of the first value and the second value is equal to the difference between the discounted price and the wholesale price. Further, when the first value is greater than zero is transferred to an account of the at least one distribution entity 108 and when the second value is greater than zero is transferred to an account of the seller 110.

The wholesale price (also referred to in this disclosure as “WP”) of an item is the price that a store or a business pays for the item that the store or business then sells to a consumer. Therefore, the wholesale price is the price that a manufacturer of a product or a primary service producer typically charges. The wholesale price may be equal to all the expenses incurred by an entity, including operating costs, material costs (including raw materials) and tax costs, for providing the item for sale. In an embodiment, the wholesale price may be equal to a sum of an actual cost of an item and a profit. In another embodiment, the wholesale price may be equal to the actual price of the item. Further, the listed price is the price that a seller (a business, a company, a person or a store) of the item charges to a consumer. The listed price is higher than the wholesale price and takes into account marketing, packaging, distribution, and other business costs. In an embodiment, the listed price can be any value greater than the wholesale price. The listed price includes the wholesale price plus profit margins of various entities, such as producers, distributors, advertisers etc. The listed price can be referred to as, “LP”, where “LP”>“WP”.

Further, a discount on a purchase involves selling an item at a price lesser than the listed price. A discount is a percentage of the total profit which can be deducted from the listed price of an item to get a discounted price of the item. The discounted price is greater than the wholesale price and lower than the listed price. In an embodiment, the end-user can get access to the discounted prices of the items requested by the end-user by using the delivery device 202 after activation. The discounted price can be referred to as, “DP”, where “LP”>“DP”>“WP”.

In an embodiment, the discount “D” on item may be equal to a difference between the listed price and the discounted price. Therefore, “D”=“LP”−“DP”. Further, the discount “D” may be less than or equal to the discount value (“DV”) associated with the delivery device 202. Therefore, “D”<=“DV”.

A profit margin (also referred to in this disclosure as “PM”) is a measure of profitability. The profit margin is part of a category of profitability ratios calculated as net income divided by revenue, or net profits divided by sales. Net income or net profit may be determined by subtracting the wholesale price from the listed price or selling price. Therefore, “PM”=“DP”−“WP”, if the item is sold at a discount.

In other embodiments, profit margins may be expressed as a percentage and measure how much of every unit (for example, a currency) of sales a company or an entity actually keeps in earnings. For example, a 20% profit margin for a company means that the company has a net income of $0.20 for each dollar of total revenue earned.

The end-users with the delivery devices 202 can use the discount value 206 on the delivery device 202 to make a purchase via the user devices 102, at a price lower than the listed price. The discount value 206 provided to the end-user may be a percentage of the total profit margin.

The discount value “DV” associated with the delivery device 202 may be selected by the facility provider 112 based on a forecasted profit margin. Further, once an end-user purchases the item at the discounted price “DP”, the unused profit margin “PM” may be distributed among the distribution entity 108, the seller 110 and facility provider 112 at a distribution ratio of x:y:z.

In an embodiment, the distribution ratio may be determined based on a commission percentage “Cp” of the distribution entity 108. In a further embodiment, the commission percentage “Cp” may be a fraction of the profit margin “PM”. In such a case, x/(x+y+z)=“Cp”. Further, the server 104 may determine a first value “V1”=x/(x+y+z)*“PM”. The server 104 may transmit the first value “V1” in the form of a currency denomination to an account of the seller 110.

In another embodiment, the distribution entity may also be determined based on a minimum threshold profit margin “Th” of the seller 110. The minimum threshold profit margin “Th” may be a fraction of the profit margin “PM”. In such a case, y/(x+y+z)=“Th”. Further, the server 104 may determine a second value “V2”=x/(x+y+z)*“PM”. The server 104 may transmit the second value “V2” in the form of a currency denomination to an account of the seller 110.

The server 104 may also determine a third value “V3”=z/(x+y+z)*“PM”. The server 104 may transmit the third value “V2” in the form of a currency denomination to an account of the facility provider 112.

In various embodiments, any one of x, y and z may be equal to zero, based on whether one or more of the distribution entity 108, the seller 110 and the facility provider 112 are entitled to a portion of the profit margin “PM”.

The server 104 may also allow only a fraction “Fr” of the discount value “DV” to be used for a single purchase. The fraction “Fr” may be determined based on a minimum amount of profit margin “PM” to be distributed among the seller 110, the distribution entity 108 and/or the facility provider 112. Therefore, the end-user may only be able to use a maximum discount equal to a product of “Fr” and “DV” for a single purchase.

The server 104 can be a computer program or a device that provides functionality for other programs or devices. A single overall computation may be distributed across multiple processes or devices. Servers can provide various functionalities, often called “services”, such as sharing data or resources among multiple clients, or performing computation. A single server can serve multiple devices, and a single device can use multiple servers. The device may connect over a network to a server. Typical servers are database servers, file servers, mail servers, print servers, game servers, web servers, and application servers. In some embodiments, the server 104 may also include a cluster of servers.

In some embodiments, the server 104 may be a cloud server. The server 104 is used to monitor and/or extract data corresponding to a particular distribution entity 108 and/or a seller 110. The user device 102 requests the server 104, by submitting a query for an item, to extract relevant results. The query may be entered by the end-user via the user interface 116. The query is indicative of a purchase of at least one item from one or more of the sellers 110, the at least one item having a wholesale price and a listed price greater than the wholesale price. The server 104 analyzes the request to provide appropriate results in accordance with the end-user request. In some embodiments, the server 104 may extract results relevant to the request specified at the user device 102 and display the results on the user device 102 through the network 118. Each of the results may provide details of an item including a corresponding discounted price, a listed price and a discount.

In an embodiment, the server 104 includes a search engine 104a. In one embodiment, the search engine 104a can be a web search engine. The web search engine is a software system that is designed to search for information on the World Wide Web. The information may be a mix of web pages, images, and other types of files. Some search engines also mine data available in databases or open directories. Unlike web directories, which are maintained only by human editors, search engines also maintain real-time information by running an algorithm. In another embodiment, the search engine 104a can include a computer readable code for implementing a search algorithm in order to search for and extract relevant data from the database 106 corresponding to the query that the end-user submits on the user device 102. On receiving the query, the server 104 may execute the search engine 104a to retrieve search results, and display the search results in one or more pages on the user interface 116 on the user device 102. In some embodiments, the search engine 104a may be a booking engine used for searching hotel listings and booking hotel rooms.

Further, the user devices 102, the server 104, the distribution entity 108, the seller 110 and the facility provider 112 may be communicably coupled to each other through the network 118. The network 118 may include a data network such as, but not restricted to, the Internet, local area network (LAN), wide area network (WAN), metropolitan area network (MAN) etc. In certain embodiments, the network 118 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the network 118 may include or otherwise cover networks or subnetworks, each of which may include, for example, a wired or wireless data pathway. The network 118 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network 118 includes a cellular telephone network to enable exchange of text or SMS messages.

Examples of the network 118 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the user devices 102, the server 104, the database 106, the distribution entity 108 and the seller 110 with each other.

In some embodiments, a processor (not shown) associated with the user device 102 may operate the application 114 and generate the user interface 116. The processor may generate options for registration of the end-user on the user device 102, and store registration details provided by the end-user on a memory (not shown) associated with the user device 102. Further, the server 104 may be communicably coupled to the user device 102 in order to access the data (including registration details) provided by the end-user on the user device 102.

In one embodiment, the server 104 utilizes the database 106 driven by the search engine 104a to implement various transactions initiated by the user devices 102. The server 104 exchanges information with the user devices 102, the sellers 110, the facility provider 112 and the distribution entities 108. For example, the server 104 can automatically receive periodic uploads of standardized data files from sellers 110 regarding products or services that are currently being offered for sale. This information can then be stored in the database 106 that can be accessed and viewed by registered distribution entities 108 of the system 100. Similarly, the server 104 receives search queries from the user devices 102 specifying parameters such as type, condition, warranty, color, location, dates, range of prices etc. In an embodiment, the server 104 can receive offer prices submitted by the end-users via the user devices 102. The user devices 102 submits their queries regarding items to the server 104. The server 104 queries the database 106 within the system 100 to determine if the specified item is available from the one or more sellers 110. The server 104 selects the respective seller 110 and displays corresponding seller 110 and item details to the end-user via the user interface 116.

A web application or an application is specially designed to display information together from diverse sources in a uniform way as per the requirements of the end-user. Applications can display data on a user interface. The extent to which content is displayed on the user interface may depend on the intended end-user and the intended purpose, as well as the diversity of the content.

The application 114 may offer services such as searching for hotels, electronic devices, stock quotes, entertainment content, etc. The application 114 provides a way for enterprises and organizations to provide a consistent look and feel with access control and procedures for multiple applications and databases, which otherwise would have been different web entities at various uniform resource locators (URL). The application 114 can restrict the purchase of items available on the application 114 depending on whether access is by a registered and authenticated end-user or an anonymous user.

The application 114 allows end-users to interact with the system 100 via the user interface 116. The end-users are often allowed to create individual accounts. The user interface 116 can be personalized based on user preferences that may include aesthetic preferences, desired data fields, location preferences, and so forth. Further, the user interface 116 may also display various details related to the end-user, such as the unique identification number associated with the delivery device 202, the discount value on the delivery device 202, user id or name of the end-user, previous transactions, list of favorite sellers or items etc.

The facility provider 112 produces one or more of the delivery devices 202, and associates the unique identification number and the discount value with the delivery device 202 via the server 104. The distribution entity 108 receives the delivery device 202 with the stored discount value 206 from the facility provider 112 of the delivery device 202. The distribution entity 108 provides the delivery device 202 to the end-user. The end-user may interact with the user interface 116 via the user device 102. After registration of the delivery device 202, the end-user can access or search for different items on the user interface 116 and purchase items at discounts using the delivery device 202 provided by the distribution entity 108. The server 104 may use the unique identification number to link the delivery device 202 with the end-user, the facility provider 112 and the one or more distribution entities 108. Further, the server 104 may also use the unique identification number to track the transactions made by the end-user, update the discount value associated with the delivery device 202 and determine payments that have to be made to the seller 110, the distribution entity 108 and/or the facility provider 112.

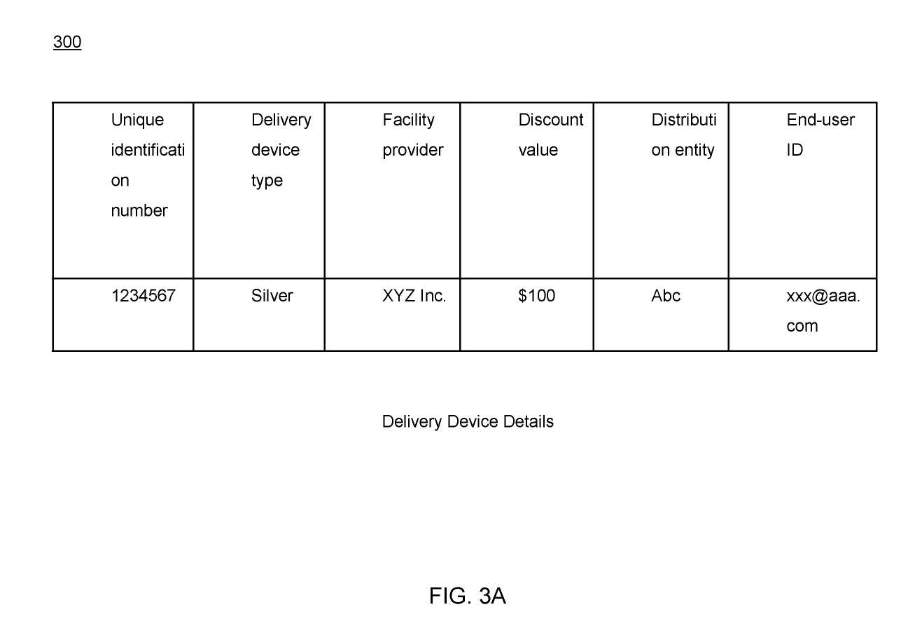

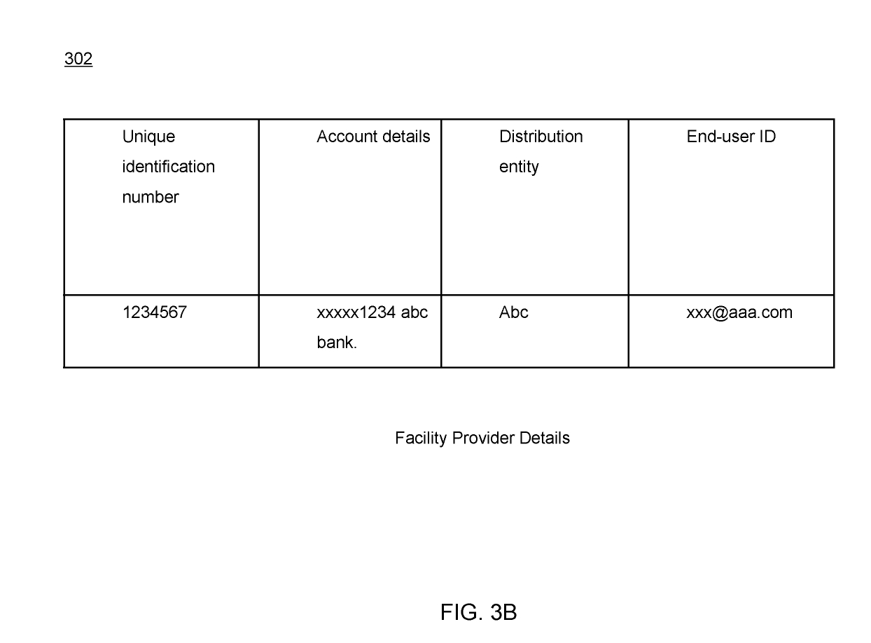

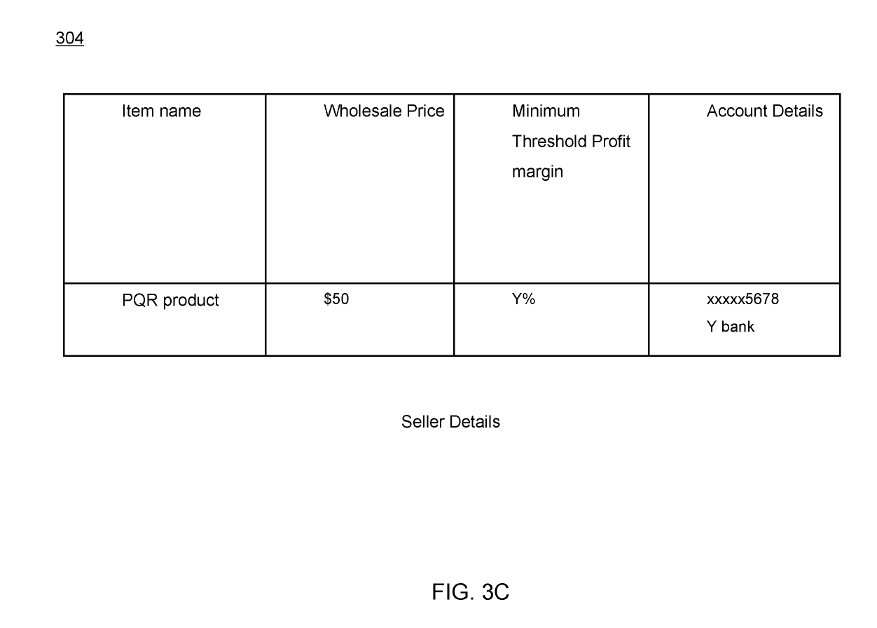

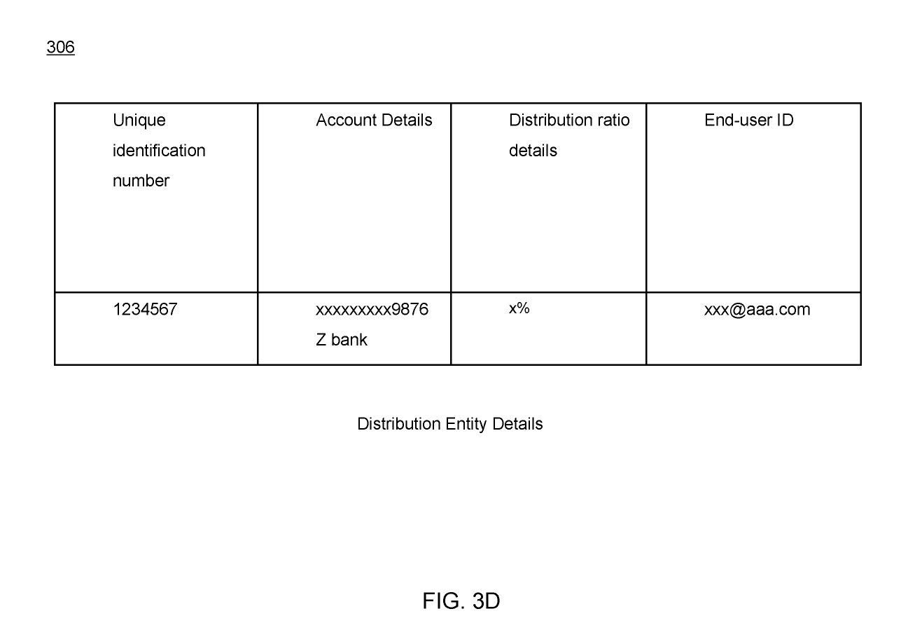

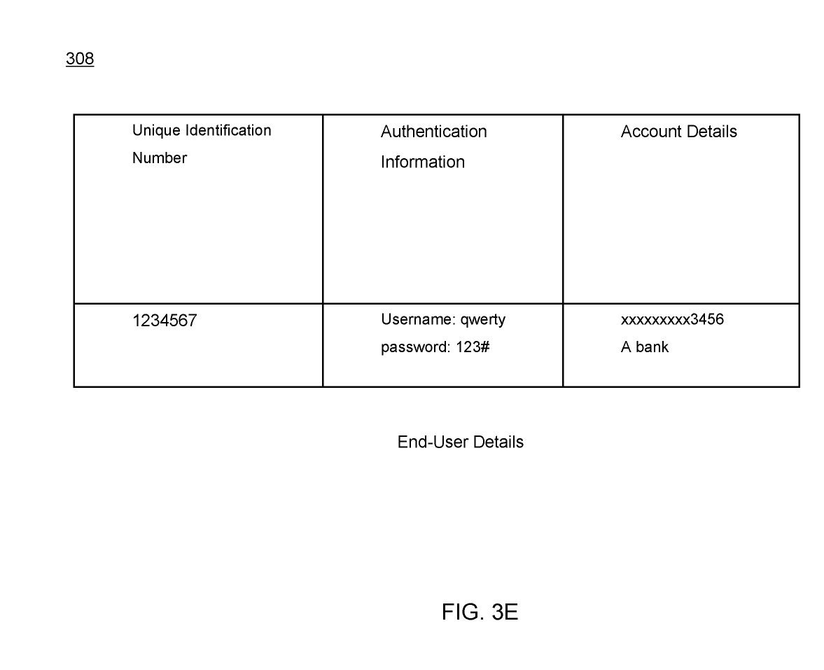

FIG. 3A illustrates a database entry 300 in the database 106, in which the server 104 stores information regarding the delivery device 202 such as, the unique identification number of the delivery device 202, the type of the delivery device (e.g. silver, gold, platinum, etc.), the facility provider 112 of the delivery device 202, the discount value 206 stored in the delivery device 202, the one or more distribution entities 108 associated with the delivery device 202, and the identification of the end-user of the delivery device 202.

FIG. 3B illustrates a database entry 302 in the database 106 regarding the facility provider 112. The details that the facility provider 112 stores in the database 106, via the server 104, can include, but not restricted to, the unique identification number of the delivery device 202, account details of the facility provider 112 for facilitation of payment on purchase of an item by the end-user, the distribution entity 108 associated with the delivery device 202 and the end-user identification details making a purchase of an item with the delivery device 202. The facility provider 112 may track the end-user and/or the distribution entity 108 by using the unique identification number of the delivery device 202.

The end-user, post receiving the delivery device 202, follows a set of instructions to activate the delivery device 202 by registering via the user interface 116. The registration process may include providing various details such as, but not restricted to, email, name, date of birth, gender, contact number, answers to security questions and so forth. The registration process may also include providing, by the end-user, the unique identification number of the delivery device 202 and/or providing the delivery device number 208 provided on the exterior surface of the delivery device 202.

In some embodiments, if the end-user submits the aforementioned information, then a one-time password (OTP) may be generated by the server 104 and the server 104 can forward the OTP to the respective user device 102 for confirmation. Once the end-user submits the correct OTP via the user interface 116, a confirmation email is sent by the server 104 to the end-user with a set of login credentials. The set of login credentials may include, but not restricted to, a user identification and a password. In some embodiments, the confirmation email can be sent to the registered email address of the end-user with a Uniform Resource Locator (URL) to access the application 114 for performing various searches in order to purchase items at discounted prices.

The seller 110 can also maintain a database entry 304 or record, as shown in FIG. 3C, in a seller database. The database entry 304 can include details, such as, but not restricted to, details of one or more items offer for on sale by the seller 110, wholesale prices and list prices of the items and account details of the seller 110. In some embodiments, the seller database (not shown) can be a part of the database 106.

FIG. 3D illustrates a database entry 306 of the distribution entity 108 stored in the database 106 via the server 104. The details stored in the database entry 306 may include, but not restricted to, unique identification numbers of the one or more delivery devices 202, account details of the distribution entity 108 in order to receive a payment upon purchase of an item with the delivery devices 202, distribution ratio details, and the end-user identification details. In an embodiment, the distribution entity 108 maintains the database entry 306 in a distributor database (not shown).

FIG. 3E illustrates a database entry 308 for an end-user. The database entry 308 may be automatically created by the server 104 upon registration of the end-user via the user device 102. The database entry 308 may include login credentials of the end-user, such as, but not restricted to, a user identification (e.g. email address, phone number, etc.), a password, and the like. The end-user can also modify the database entry 308 via the user interface 116. The database entry 308 may also include other details, such as, but not restricted to, the unique identification number of the delivery device 202, account details of the end-user, location details, user preferences, and so forth.

The database entries 300, 302, 304, 306 and 308 may be linked with each other in a relational database, for example, the database 106. The unique identification number may be used to track transactions performed by the end-users and also relate the end-users, the sellers 110, the distribution entities 108 and the facility provider 112 with each other.

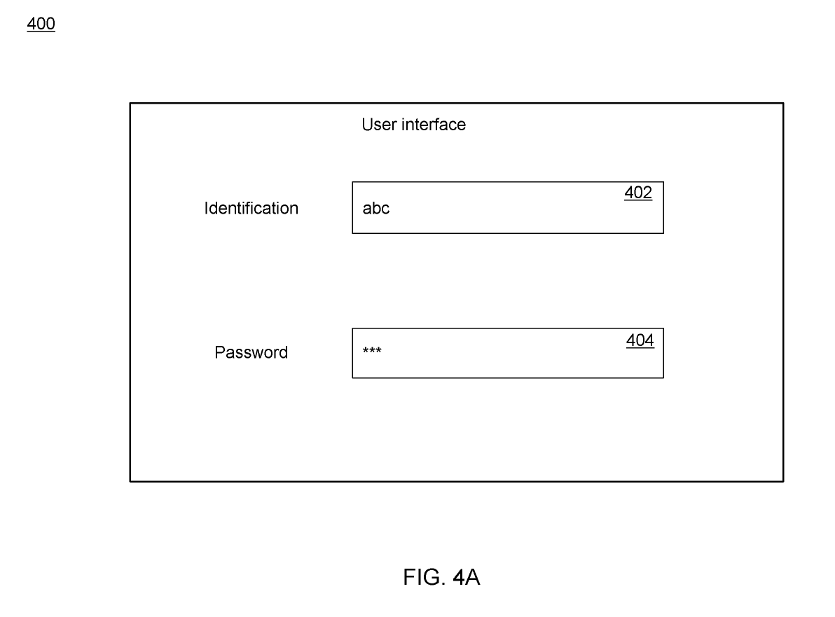

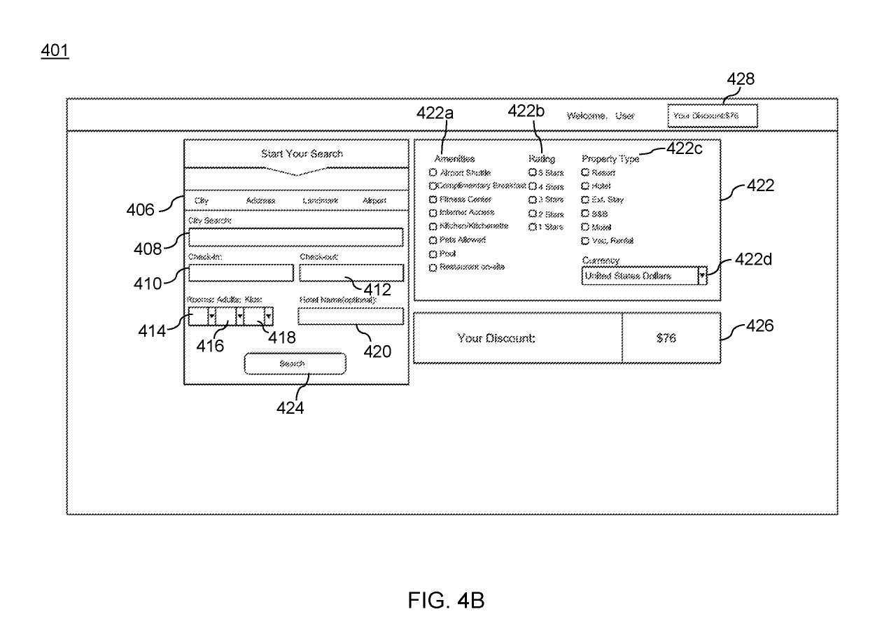

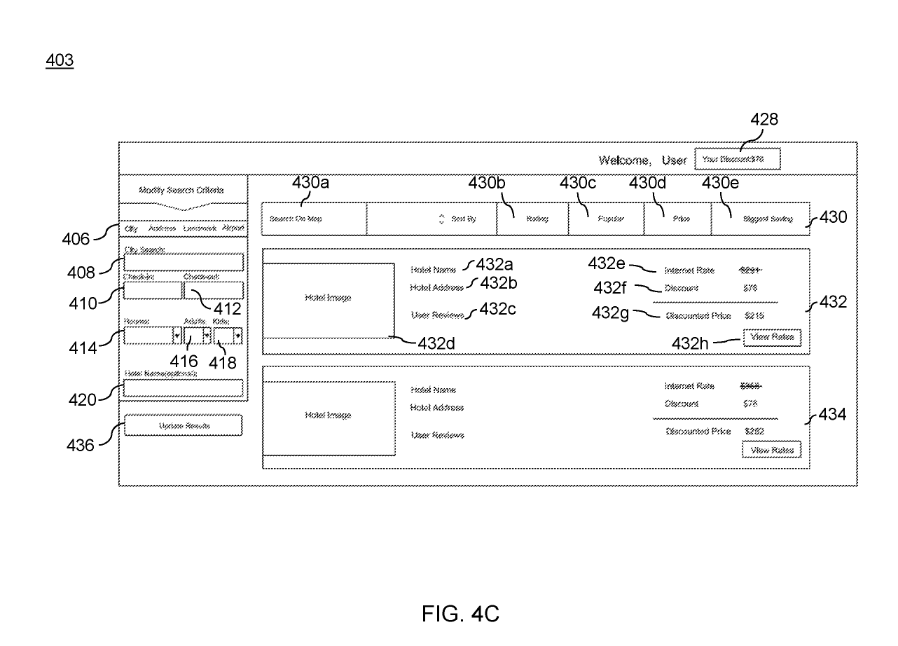

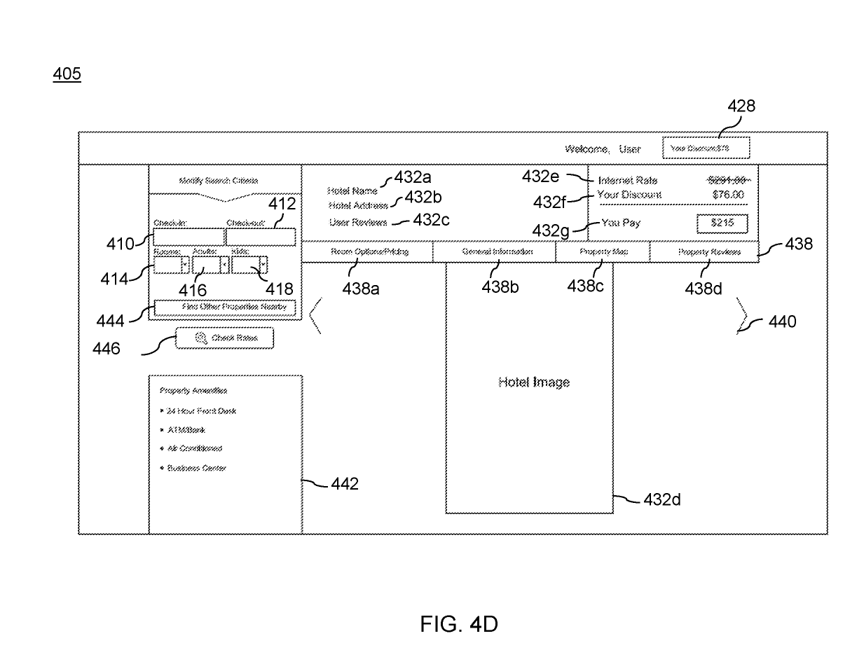

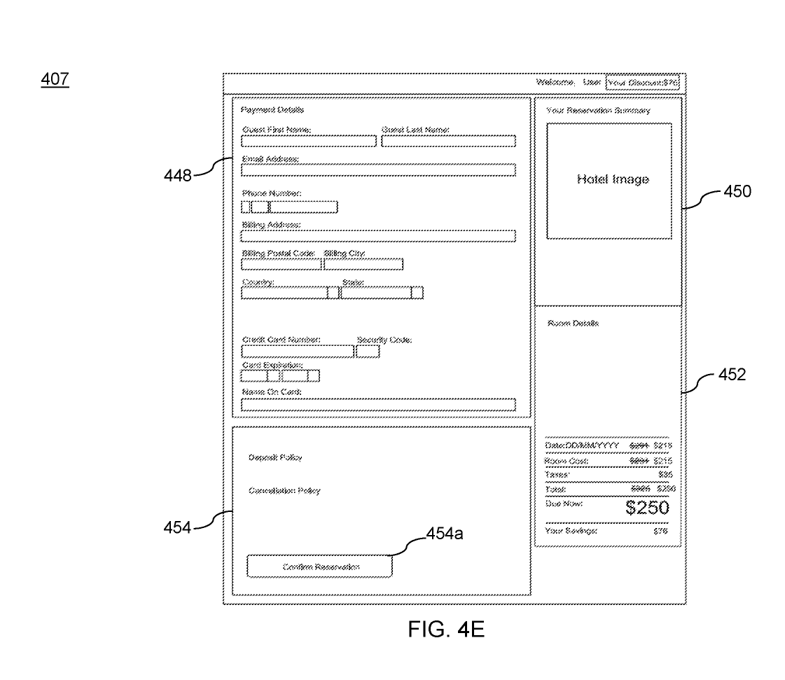

FIG. 4A illustrates a login page 400 of the user interface 116. The login page 400 is password-protected, and provides secure searching and transactions to the end-user. The login page 400 of the user interface 116 can be generated by the application 114. The user interface 116 can be a web based interface that can communicate with the server 104. The user interface 116 includes fields to receive a set of login credentials from the end-users. The fields include, but are not restricted to, a user identification field 402 and a password field 404. The end-users may enter a set of login credentials at the user interface 116 via the user devices 102. The set of login credentials include a user identification and a corresponding password. The end-user identification and the password can be received through the user identification field 402 and the password field 404, respectively. The user identification field 402 can be, but not restricted to, a text box. The user identification can be, but not restricted to, an email address, a phone number, an alphanumeric string, and so forth. Further, the password can include, but not restricted to, a set of special characters, a set of alphabets, a set of numeric values or a combination thereof. The characters of the password field 404 are hidden during user input in order to prevent revealing of the password.

In an exemplary embodiment, the login page 400 for the end-user can also be used as a login page for the sellers 110, the distribution entities 108 and/or the facility provider 112. In such a case, the login page 400 may receive an additional input indicative of entity type, for example, an end-user, a distribution entity, a seller, or a facility provider.

The application 114 transmits the set of login credentials to the server 104. The server 104 can receive the set of login credentials from the application 114 and searches for the set of login credentials in the database 106. The server 104 authenticates the user device 102 if the set of login credentials matches an entry present in the database 106. In case the set of login credentials does not match an entry in the database 106, the server 104 denies access to the corresponding user device 102 to access data from the database 106. In an embodiment, if the login credentials do not match an entry in the database 106, then the server 104 can automatically redirect the corresponding user device 102 to a registration page (not shown). The end-user can follow the registration process to activate the respective delivery device 202 and provides the end-user with the set of login credentials. The server 104 can generate a new set of login credentials for the user device 102 using contact information provided by the end-user while registering. In an embodiment, if the end-user inputs incorrect login credentials, the server 104 may alert the user device 102 regarding the incorrect login credentials by displaying an alert message in the form of an alert box, a pop-up window, and the like. Upon successful authentication of login details, the end-user is directed to a page 401 that is illustrated in FIG. 4B.

The page 401 displays fields to search for hotel bookings at a particular location (for example, a city) by submitting relevant data. In another embodiment, the page 401 can include fields to purchase other products, such as, but not restricted to, electronic devices, apparels, and so forth. The page 401 displays fields to be filled in with relevant information by the end-user for booking of a hotel. The relevant fields can include a city, check-in date, check-out date, amenities provided by the hotel, and the like. The page 401 includes a search panel 406. The search panel 406 includes different click buttons for different entities, such as, but not restricted to, click buttons for city, address, landmarks, airport, and so forth. The click buttons in the search panel 406 may provide detailed information on the event of click, regarding every entity mentioned on the click buttons in the search panel 406. The page 401 can also include one or more text boxes for corresponding fields. The text boxes can be filled by the end-user as the end-user's preferences. Specifically, the page 401 enables the end-user to search for a city via a city search field 408. The end-user can further provide check-in and check-out details for the booking of the hotel at the check-in field 410 and the check-out field 412, respectively. The check-in and the check-out details may require the end-user to fill in dates as per the end-user's requirements. The end-user can also provide information regarding the number of room(s) required at rooms field 414. The rooms field 414 may be a drop-down menu, where the list in the drop-down menu may contain numerical values to facilitate the selection of rooms required by the end-user. The end-user may further select number of adults for the room by selecting a numerical value from a drop-down menu at the adults field 416. The end-user may select a numerical value from a drop-down menu at a kids field 418 for selecting a number of kids for the room(s). The end-user can also optionally mention a name of the hotel at the hotel name field 420.

The page 401 also includes a filters panel 422, that can include, but not restricted to, an amenities field 422a, a rating field 422b, a property type field 422c and a currency field 422d. The end-user can choose one or more amenities, such as but not limited to, airport shuttle requirement, complimentary breakfast requirement, fitness center requirement, and the like, by selecting one or more check-boxes provided in the amenities field 422a. The end-user can select one or more hotel ratings required by the end-user via the rating field 422b, such as, 5 stars, 4 stars, 3 stars, and so forth, by selecting one or more check-boxes corresponding to the aforementioned ratings. The end-user can further select a type of property required by the end-user for booking at the property type field 422c, such as, resort, hotel, motel, and the like. The end-user can select the property types by selecting one or more check-boxes corresponding to the aforementioned property types at the property type field 422c. The end-user can also select a type of currency by selecting a name of the country form a drop-down menu at the currency field 422d corresponding to the type of currency required by the end-user to make the payment for booking the hotel room(s). The end-user can then click a search button 424 to search for the given fields filled by the end-user within the database 106. The page 401 also enables the end-user to view the discount value available in the delivery device 202 at the discount field 426.

Though the embodiment, as illustrated in FIG. 4B, is related to hotel bookings, the page 401 can also be modified to search for products. In such a case, the page 401 can include fields related to product specifications, model numbers, manufacturer details, price ranges, and the like.

In an embodiment, the application 114 receives data filled by the end-user in the various fields on the page 401 in the form of a query. The query may be a set of keywords corresponding to the various fields filled by the end-user. The application 114 may also generate the query on the event of a click of the search button 424 by the end-user. The application 114 may then transmit the query to the server 104 over the network 118.

In an embodiment, the search engine 104a present at the server 104 receives the query and searches for data corresponding to one or more hotels and extracts search results from the database 106. The server 104 may transmit the search results to the user device 102. The application 114 then displays the search results at a page 403 on the user interface 116, as illustrated in FIG. 4C.

The page 403 may display one or more search results corresponding to the preferences provided by the end-user in the query. The end-user can search for locations of the listed hotels on a map by clicking a map field 430a. The page 403 includes a sorting panel 430 that provides buttons for a rating field 430b, a popular field 430c, a price field 430d and a biggest saving field 430e. The search results displayed on the page 403 may be sorted based on rating, popularity, and the like, in accordance with the preferences of the end-user. Specifically, the end-user can select one or more of the rating field 430b, the popular field 430c, the price field 430d, and the biggest saving field 430e for appropriately sorting the search results. The page 403 displays one or more search results at display panels 432 and 434. The search result in display panel 432 provides a name of a hotel at a hotel name field 432a along with a hotel address corresponding to the hotel at a hotel address field 432b. The end-user can also view any available user reviews provided by one or more other patrons of the hotel by clicking a user reviews button 432c. The page 403 can also display one or more images 432d of the hotel. The page 403 further displays an internet rate 432e that is the listed price of a room(s) of the hotel, and a discount 432f that is applied on the listed price to enable the end-user to book the hotel at a discounted price 432g. The discount 432f that is applied on the listed price of the room(s) can be equal to or lesser than the discount value available in the delivery device 202 of the end-user. The rates corresponding to one or more rooms of the hotel are displayed upon clicking a rates button 432h on the page 403. The display panel 434 includes similar fields corresponding to another hotel.

In some embodiments, the page 403 displays any number of appropriate search results, each result being displayed in a corresponding display panel. In accordance with user preferences, a limited number of search results may be displayed at a time with the other search results being displayed in additional pages. Options for display preferences may be provided to the end-user that dictate the number of search results to be shown on the page 403. For example, display preferences of the end-user may direct the application 114 to display two search results (as shown in FIG. 4C) on a single page. The page 403 may provide further options (not shown) to update the page 403 so as to display the next set of two search results.

The page 403 further includes the city search field 408, the check-in field 410, the check-out field 412, the rooms field 414, the adults field 416, the kids field 418 and/or the hotel name field 420 that are obtained from the page 401. The application 114 enables the end-user to change the preferences provided by the end-user at the city search field 408, the check-in field 410, the check-out field 412, the rooms field 414, the adults field 416, the kids field 418 and/or the hotel name field 420. The end-user can further click the update results button 436 to update the results that the page 403 displays the display panels 432 and 434. Further, the end-user may select one of the hotels from the multiple search results that the page 403 displays to make a reservation. Upon selection of any of the search results in the display panels 432 and 434, the application 114 redirects the end-user to a page 405 containing further options for making a reservation, payment and the like. In an example, the end-user selects the hotel at the display panel 432.

FIG. 4D illustrates the page 405 of the user interface 116. The page 405 provides one or more options for available rooms through a room options/pricing field 438a and general information regarding the room or the hotel through a general information field 438b. For example, the end-user can view different kinds of rooms available at the hotel and their respective costs by clicking the room options/pricing field 438a. The information regarding the available rooms may be displayed on the page 405 or in a separate popup window. Based on the selection of a room, various pricing information including the internet rate 432e, the discount 432f and discounted price 432g are updated accordingly. Further, a property map of the hotel and reviews can be viewed by clicking on a property map field 438c and a property reviews field 438d respectively. The room options/pricing field 438a, the general information field 438b, the property map field 438c and the property reviews field 438d are displayed on a menu panel 438. The page 405 further displays images 432d of the various rooms. The end-user can navigate left or right to view other images of the hotel or the room by clicking on scrolling arrows 440. Details of the room selected are displayed at a property amenities field 442. Such details may include, but not restricted to, front desk availability, ATM/bank facility, air conditioning in the room, and the like. Further, the page 405 enables the end-user to make changes in the requirements of the room by changing the check-in and check-out dates at the check-in field 410 and the check-out field 412. Further changes can also be made at the rooms field 414, the adults field 416 and/or the kids field 418. The page 405 further provides additional options to search for other hotels corresponding to the preferences provided by the end-user on the page 403 by clicking a Find Other Properties Nearby field 444. In some embodiments, the end-user may be redirected back to the page 403. The end-user may also check rates for different hotels or room by clicking a Check Rates field 446. The Find Other Properties Nearby field 444 and the Check Rates field 446 can be, but not restricted to a click button. Upon finalization of the preferences, the end-user can select a particular hotel room booking by clicking a submit button (not shown). The application 114 may then display a final payment page 407.

FIG. 4E illustrates the final payment page 407. The application 114 enables the end-user to make the booking of the selected room of the selected hotel by making a required payment for the service on the final payment page 407. The final payment page 407 displays the amount of the stored discount value 206 used from the delivery device 202. The end-user can provide various payment details for making the payment of the room(s) at the payment details panel 448. The various payment details may include, personal information of the end-user, such as, but not restricted to, a first name, a last name, an email address, a phone number, a billing address, a billing postal code, a billing city and the like. The payment details can also include details regarding a payment mode and authentication details, such as, but not restricted to, a credit card number, a security code, a card expiration date, a name on the card and the like. The page 407 may also display a hotel image at the image field 450. The image field 450 may contain one or more images of the hotel or a caption. A display panel 452 provides details regarding the payment due by the end-user after addition of appropriate taxes and deduction of the discount value provided by the activated delivery device 202 from the listed price. The details may include a date on which the payment is made, room cost, i.e., the listed price of the room of the hotel selected, addition of taxes, deduction of discount from the listed price, and total amount due to be paid by the end-user. The end-user can also view information like deposit policy and cancellation policy at a policy panel 454.

Upon receiving the payment details from the end-user and detecting the clicking of a confirm button 454a, the application 114 can generate a request that is transmitted to the server 104 from the user device 102 over the network 118. The request is indicative of the purchase of at least one item (the hotel room booking) by the end-user. The request may include payment information towards reserving the selected room, the payment information including the listed price, taxes to be paid and the discount provided. Additionally, the payment information can include details regarding a payment mode and authentication details, such as, but not restricted to, a credit card number, a security code, a card expiration date, a name on the card and the like. In some embodiments, details regarding the payment mode can be extracted from the registration information of the end-user. The request also includes details of the hotel booking, the unique identification number associated with the delivery device 202, and details of the seller 110 associated with the hotel. The server 104, on receiving the request, may also verify the payment information provided within the request.

Once the payment is verified by the server 104, the server 104 may transmit an acknowledgement to the user device 102. The application 114, on receiving the acknowledgement, may enable the end-user to purchase the item (the hotel room booking) at the discounted price.

The server 104, using the database 106, determines the one or more distribution entities 108, the seller 110, and the facility provider 112 associated with the delivery device 202. The server 104 may then determine the distribution ration corresponding to the seller 110, the one or more distribution entities 108, the seller 110, and the facility provider 112. The unused profit margin is distributed based on the distribution ratio for the seller 110, the one or more distribution entities 108 distributing a given delivery device, and the facility provider 112.

The server 104 then distributes the unused profit margin, that is equal to a difference between the discounted price and the wholesale price of the item, among the seller 110, the facility provider 112 of the delivery device 202 and/or the one or more distribution entities 108 of the delivery device in the form of an equivalent currency denomination. Specifically, the server 104 may transmit a first value, a second value and a third value to an account of the seller 110, an account of the at least one distribution entity 108 and an account of the facility provider 112, respectively, based on the division of the unused profit margin. The server 104 can extract requisite account details from appropriate database entries (shown in FIGS. 3A-3E) in the database 106. The account details can be bank account details, electronic wallet details, card details, and the like.

Further, the server 104 can track the transaction using the unique identification number of the delivery device 202. The server 104 can also track the one or more distribution entities 108 of the delivery device 202 used by the end-user for the purchase.

The application 114 can also deduct the used discount from the discount value associated with the delivery device 202. Accordingly, the pages 401, 403 and 405 may be updated with the new discount value. Moreover, the server 104 can also update appropriate entries in the database 106 with the new discount value corresponding to the delivery device 202.

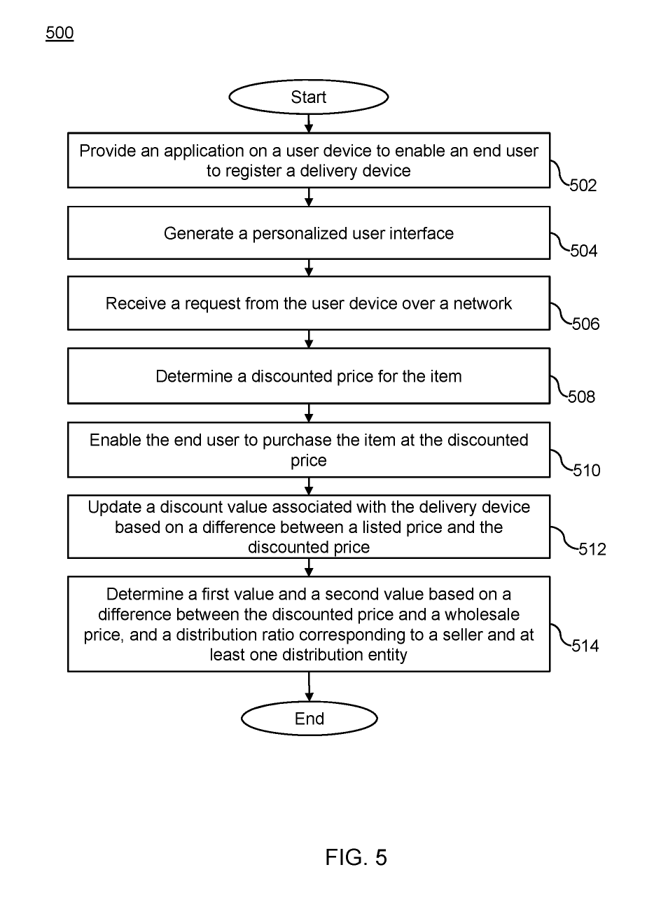

FIG. 5 illustrates a method 500 for facilitating a purchase in accordance with the disclosed subject matter. This flowchart is merely provided for exemplary purposes, and embodiments are intended to include or otherwise cover any methods or procedures for facilitating purchases of goods or services.

At step 502, the server 104 provides the application 114 on the user device 102 to enable an end-user to register a delivery device 202. The delivery device 202 is associated with a discount value and at least one distribution entity 108. The discount value is stored in the form of a currency denomination on the delivery device 202. Alternatively, the discount value may be based on a particular number of points allocated to the delivery device 202, each point being equivalent to one or more units of currency. In some embodiments, the delivery device 202 can be, but not restricted to, a card or a coupon. The server 104 also assigns a unique identification number to the delivery device 202. Further, the server 104 stores the unique identification number associated with the delivery device 202 and the discount value associated with the delivery device 202 in a database 106 connected to the server 104. Also, the server 104 associates at least one distribution entity 108 with the delivery device 202 using the unique identification number.

Next, at step 504, the application 114 generates a personalized user interface 116. The end-user can follow a registration process on the personalized user interface 116 via the user device 102. The server 104 receives registration details from the user device 102 over the network 118. The registration details include the unique identification number. Further, the server 104 may activate the delivery device 202 upon registration by the end-user by making required changes in the database 106. The server 104 updates the database 106 with the data acquired from the registered delivery device 202. Also, the personalized user interface 116 displays the discount value to the end-user. The end-user can also submit a query to the server 104 via the user device 102 to search for an item. The query may consist of normal terms in the user's language, without any special syntax or format. The query can be in any form, including a statement, a question or a simple set of keywords. Upon receiving query, the server 104 uses the query to extract a list of items from the database 106, and transmits the list of items to the user device 102. The application 114 then displays the list of items from multiple sellers 110 on the user interface 116.

At step 506, the server 104 receives a request from the user device 102 over a network 118. The request is indicative of a purchase of at least one item from a seller, the at least one item having a wholesale price and a listed price greater than the wholesale price. The item can be, but not restricted to, a product (e.g. Electronic device, apparels, books, etc.) or a service (e.g. Booking a hotel).

Further, the server 104 may receive account details of the at least one distribution entity 108 and one or more sellers 110 over the network 118. The server 104 stores the account details (e.g. account number, bank name, etc.) of the at least one distribution entity 108 and the one or more sellers 110 in the database 106.

In some embodiments, the server 104 stores a plurality of distribution ratios for a plurality of pairs of sellers 110 and distribution entities 108 in the database 106. The server 104 determines the distribution ratio corresponding to the seller 110 and at least one distribution entity 108 from the database 106.

At step 508, the server 104 determines a discounted price for the item. The discounted price is lesser than the listed price and greater or lesser than the wholesale price. The difference between the listed price and the discounted price is less than or equal to the discount value 206.

Next, at step 510, the application 114 enables the end-user to purchase the item at the discounted price. The server 104 applies the discount on the item to be purchased by the end-user.

At step 512, the server 104 updates the discount value 206 associated with the delivery device 202, in accordance with the difference between the listed price and the discounted price for the item. The user interface 116 displays the updated discount value 206.

At step 514, the server 104 determines a first value and a second value based on a difference between the discounted price and the wholesale price, and the distribution ratio corresponding to the seller 110 and at least one distribution entity 108. The sum of the first value and the second value is equal to the difference between the discounted price and the wholesale price. Further, when the first value is greater than zero is transferred to an account of the at least one distribution entity 108 and when the second value is greater than zero is transferred to an account of the seller 110.

The present disclosure can be implemented in various exemplary embodiments provided below.

For example, a social networking company, hosting a travel bookings portal, provides various independent business owners with hotel cards. The independent business owners offer services or goods that are patronized by varying numbers of end-users. The hotel cards are distributed to the various end-users or patrons by way of advertised offers or depending on the amount of patronage received by an independent business owner from an end-user. Through the activation of the distributed hotel cards, the independent business owners provide the social networking company with a number of end-users. Each of the hotel cards may have a stored value in the form of currency denomination to be used as a discount. The end-users of the card may use the one or more cards to book a hotel room at a discounted price that is lesser than the listed price of the room, using the discount value stored in the hotel card. After the end-user books the hotel room and saves money on the purchase, an amount of the profit is paid to the independent business owner that distributed the hotel card to the end-user.

In another example, a sales and marketing company, representing various products, may distribute hotel cards, each with a stored value, to end-users to incentivize people to purchase the products represented by the sales and marketing company. If the end-user uses the hotel card to make a booking for a hotel room, then, the sales and marketing company gets paid.

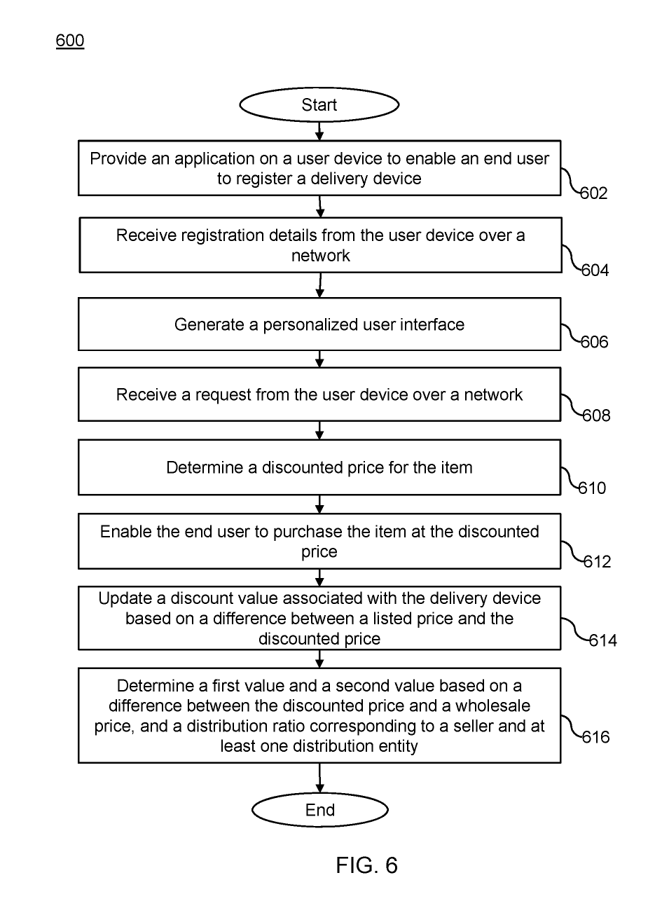

FIG. 6 illustrates a method 600 for facilitating a purchase in accordance with the disclosed subject matter. This flowchart is merely provided for exemplary purposes, and embodiments are intended to include or otherwise cover any methods or procedures for facilitating purchases of goods or services.

At step 602, the server 104 provides the application 114 on the user device 102 to enable an end-user to register the delivery device 202. The delivery device 202 is associated with the discount value 206 and at least one distribution entity 108. The discount value 206 is stored in the form of a currency denomination on the delivery device 202. In some embodiments, the delivery device 202 can be, but not restricted to, a card or a coupon. The server 104 also assigns a unique identification number and the discount value to the delivery device. Further, the server 104 stores the unique identification number associated with the delivery device 202 and the discount value associated with the delivery device 202 in a database 106 connected to the server 104. Also, the server 104 associates at least one distribution entity 108 with the delivery device 202 using the unique identification number.

At step 604, the server 104 receives registration details from the user device 102 over the network 118. The registration details include a unique identification number and the delivery device is activated upon registration by the end-user. In some embodiments, the end-user may follow a set of instructions such as, providing personal information (name, email, phone number, etc.), unique identification number, and so forth. Further, the server 104 may activate the delivery device 202 upon registration by the end-user by making required changes in the database 106. The server 104 updates the database 106 with the data acquired from the registered delivery device 202.

Next, at step 606, the application 114 generates a personalized user interface 116. The personalized user interface 116 displays the discount value 206 to the end-user. The end-user may submit a query to the server 104 via the user device 102 to make a purchase of the item corresponding to the query. The query may consist of normal terms in the user's language, without any special syntax or format. The query can be in any form, including a statement, a question or a simple set of keywords. The end-user can request the server 104 to search for the items corresponding to the query by submitting the query. The server 104 receives the query from the user device 102, over the network 118. The server 104 searches for relevant results in the database 106 via the search engine 104a to display, via the application 114, the relevant results on the user interface 116.

At step 608, the server 104 receives a request from the user device 102 over the network 118. The request is indicative of a purchase of at least one item from a seller, the at least one item having a wholesale price and a listed price greater than the wholesale price. The item can be, but not restricted to, a product (e.g. Electronic device, apparels, books, etc.) or a service (e.g. Booking a hotel).

Further, the server 104 may receive account details of the at least one distribution entity 108 and one or more facility provider 112 over the network 118. The server 104 then stores the account details (e.g. account number, bank name, etc.) of the at least one distribution entity 108 and the one or more facility provider 112 in the database 106.

In some embodiments, the server 104 stores a plurality of distribution ratios for a plurality of pairs of facility providers 112 and distribution entities 108 in the database 106. The server 104 determines the distribution ratio corresponding to the facility provider 112 and at least one distribution entity 108 from the database 106.

At step 610, the server 104 determines a discounted price for the item. The discounted price is lesser than the listed price and greater or lesser than the wholesale price. The difference between the listed price and the discounted price is less than or equal to the discount value 206.

Next, at step 612, the application 114 enables the end-user to purchase the item at the discounted price.

At step 614, the server 104 updates the discount value 206 associated with the delivery device 202. The personalized user interface displays the updated discount value 206.

At step 616, the server 104 determines a first value and a second value based on a difference between the discounted price and the wholesale price and a distribution ratio corresponding to the seller 110 and at least one distribution entity 108. The sum of the first value and the second value is equal to the difference between the discounted price and the wholesale price. Further, when the first value is greater than zero is transferred to an account of the at least one distribution entity 108 and when the second value is greater than zero is transferred to an account of the seller 110.

In an example, a direct mail marketing company uses hotel cards with a stored discount value to incentivize people to respond to direct mails, that the marketing company sends. The direct mail may represent various other companies and products. The hotel card works as an income producer as the direct mail marketing company gets paid every time the end-user uses the hotel card to reserve hotels at discounted prices.

In another example, university alumni associations provide hotel cards, each with a stored discount value, to alumni members who pay annual dues to support their university. The hotel cards work as an income provider to the university because the university and/or the alumni association gets paid every time an alumnus uses a hotel card to reserve hotels at discounted prices.

In yet another example, multiple distribution entities 108 provide the delivery device 202 with a discount value of $100 to an end-user. The end-user searches for a hotel using the search engine 104a that has an internet price of $100. If the total margin available on this room is $30, the wholesale cost of the room is $70. The server 104 allows the end-user to use $15 of the stored value on the delivery device 202 to buy down the price of the room to $85, leaving $15 in unused profit margin. The unused profit margin is then distributed as income to any number of distribution entities 108. All the transactions are tracked using the unique identification number.

A Currency Account table is provided which contains a stored value of points that represent a pre-determined number of real currency dollars, which may be used, in whole or in part, against Discount Amount, to arrive at Discounted Price. Note, The Discount Amount, once dynamically calculated, will be subtracted from Retail Price (Retail Price of Commodity—i.e., an item that can be sold that has margin, Hotel Room, Condo, Cruise . . . anything) resulting in the Discounted Price (the amount the User pays for the commodity and it is dynamically calculated by taking the dynamically calculated Discount Amount and subtracting it from the dynamically calculated Retail Price). This is dynamically calculated by taking the dynamically calculated Retail Price, and multiplying it by a pre-determined Discount Percentage (Pre-determined percentage that may vary by client/campaign/marketing program, etc., which percentage will be used to dynamically calculate the Discount Amount). The Retail Price, Discount Amount, Discounted Price cannot be calculated manually nor could a computer do this by itself, without the entire invention (formula/method) being applied, dynamically, and live, in real-time, because there is no way to forecast for what the User would search.

The Currency Account is initially pre-determined, both as to total value in real dollars, and in terms of how many points equate to one dollar in real currency. For example, one User may have ten points equal one dollar in real currency, and another User may have one point equal one dollar in real currency. This is pre-determined for each User Type by a client.

Once the Discounted Price is established, the invention dynamically applies all or a portion of the points stored in the Currency Account towards the Discount Amount, allowing the User to purchase the Commodity for the Discounted Price.

Any unused points are stored in the Currency Account Table for future use. When all points in the Currency Account have been used, there will be any number of ways that a User may obtain additional points or not.

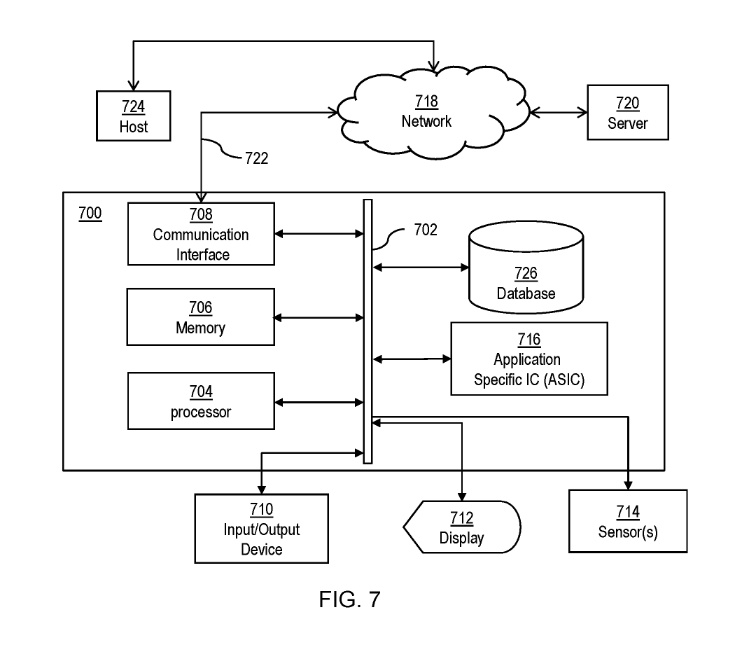

FIG. 7 illustrates a computer system 700 upon which the operation of the user device 102, the server 104 and/or the database 106 may be implemented. Although, the computer system 700 is depicted with respect to a particular device or equipment, it is contemplated that other devices or equipment (e.g., network elements, servers, etc.) within FIG. 7 can deploy the illustrated hardware and components of system. The computer system 700 is programmed (e.g., via computer program code or instructions) to retrieve a set of data from the server 104 and to display the retrieved data on the user interface 116 described herein and includes a communication mechanism such as a bus 702 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 702 includes one or more parallel conductors of information so that information is transferred quickly among devices coupled to the bus 702. A processor 704 for processing information are coupled with the bus 702.

The processor 704 performs a set of operations on information as specified by an end-user. The computer program code is a set of instructions or statements providing instructions for the operation of the processor 704 and/or the computer system 700 to perform specified functions. The code, for example, may be written in a computer programming language that is compiled into a native instruction set of the processor 704. The code may also be written directly using the native instruction set (e.g., machine language). The set of operations include bringing information in from the bus 702 and placing information on the bus 702. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 704, such as a sequence of operation codes, constitute processor instructions, also called computer system instructions or, simply, computer instructions. The processor 704 may be implemented as mechanical, electrical, magnetic, optical, chemical, or quantum components, among others, alone or in combination.

The computer system 700 also includes a memory 706 coupled to the bus 702. The memory 706, such as a Random Access Memory (RAM) or any other dynamic storage device, stores information including processor instructions for storing information and instructions to be executed by the processor 704. The dynamic memory 706 allows information stored therein to be changed by the computer system 700. RAM allows a unit of information stored at a location called a memory address to be stored and retrieved independently of information at neighboring addresses. The memory 706 is also used by the processor 704 to store temporary values during execution of processor instructions. The computer system 700 also includes a Read Only Memory (ROM) or any other static storage device coupled to the bus 702 for storing static information, including instructions, that is not changed by the computer system 700. Some memory is composed of volatile storage that loses the information stored thereon when power is lost. Also coupled to the bus 702 is a non-volatile (persistent) storage device 708, such as a magnetic disk, a solid state disk, optical disk or flash card, for storing information, including instructions, that persists even when the computer system 700 is turned off or otherwise loses power.

Information, including instructions for processing the preconfigured data collection is provided to the bus 702 for use by the processor 704 from an external input device 710, such as a keyboard containing alphanumeric keys operated by a human user, a microphone, an Infrared (IR) remote control, a joystick, a game pad, a stylus pen, a touch screen, or a sensor. The sensor detects conditions in its vicinity and transforms those detections into physical expression compatible with the measurable phenomenon used to represent information in the computer system 700. Other external devices coupled to the bus 702, used primarily for interacting with humans, include a display 712, such as a Cathode Ray Tube (CRT), a Liquid Crystal Display (LCD), a Light Emitting Diode (LED) display, an organic LED (OLED) display, active matrix display, Electrophoretic Display (EPD), a plasma screen, or a printer for presenting text or images, and a pointing device 716, such as a mouse, a trackball, cursor direction keys, or a motion sensor, for controlling a position of a small cursor image presented on the display 712 and issuing commands associated with graphical elements presented on the display 712, and one or more camera sensors 714 for capturing, recording and causing to store one or more still and/or moving images (e.g., videos, movies, etc.) which also may comprise audio recordings. Further, the display 712 may be a touch enabled display such as capacitive or resistive screen. In some embodiments, for example, in embodiments in which the computer system 700 performs all functions automatically without human input, one or more of the external input device 710, and the display 712 may be omitted.

In the illustrated embodiment, special purpose hardware, such as an ASIC 716, is coupled to the bus 702. The special purpose hardware is configured to perform operations not performed by the processor 704 quickly enough for special purposes. Examples of ASICs include graphics accelerator cards for generating images for the display 712, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 700 also includes one or more instances of a communication interface 718 coupled to the bus 702. The communication interface 718 provides a one-way or two-way communication coupling to a variety of external devices that operate with their own processors, such as printers, scanners and external disks. In general, the coupling is with a network link 720 that is connected to a local network 722 to which a variety of external devices with their own processors are connected. For example, the communication interface 718 may be a parallel port or a serial port or a Universal Serial Bus (USB) port on a personal computer. In some embodiments, the communication interface 718 is an Integrated Services Digital Network (ISDN) card, a Digital Subscriber Line (DSL) card, or a telephone modem that provides an information communication connection to a corresponding type of a telephone line. In some embodiments, the communication interface 718 is a cable modem that converts signals on the bus 702 into signals for a communication connection over a coaxial cable or into optical signals for a communication connection over a fiber optic cable. As another example, the communications interface 718 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 718 sends or receives or both sends and receives electrical, acoustic or electromagnetic signals, including infrared and optical signals that carry information streams, such as digital data. For example, in wireless handheld devices, such as mobile telephones like cell phones, the communication interface 718 includes a radio band electromagnetic transmitter and receiver called a radio transceiver. In certain embodiments, the communication interface 718 enables connection to the network 118 for processing the preconfigured data collection associated with the campaign. Further, the communication interface 718 can include peripheral interface devices, such as a thunderbolt interface, a Personal Computer Memory Card International Association (PCMCIA) interface, etc. Although a single communication interface 718 is depicted, multiple communication interfaces can also be employed.

The term “computer-readable medium” as used herein refers to any medium that participates in providing information to the processor 704, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 708. Volatile media include, for example, the dynamic memory 706. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 716.

The network link 720 typically provides information communication using transmission media through one or more networks to other devices that use or process the information. For example, the network link 720 may provide a connection through the local network 722 to a host computer 724 or to ISP equipment operated by an Internet Service Provider (ISP).

A computer called a server 726, connected to the Internet, hosts a process that provides a service in response to information received over the Internet. For example, the server 726 hosts a process that provides information representing video data for presentation at the display 712. It is contemplated that the components of the computer system 700 can be deployed in various configurations within other computer systems, e.g., the host 724 and the server 726.

At least some embodiments of the invention are related to the use of the computer system 700 for implementing some or all of the techniques described herein. According to one embodiment of the invention, those techniques are performed by the computer system 700 in response to the processor 704 executing one or more sequences of one or more processor instructions contained in the memory 706. Such instructions, also called computer instructions, software and program code, may be read into the memory 706 from another computer-readable medium such as the storage device 708 or the network link 720. Execution of the sequences of instructions contained in the memory 706 causes the processor 704 to perform one or more of the method steps described herein. In alternative embodiments, hardware, such as the ASIC 716, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 704 for execution. For example, instructions and data may initially be carried on a magnetic disk of a remote computer such as the host 724. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 720. An infrared detector serving as the communication interface 718 receives the instructions and data carried in the infrared signal and places information representing the instructions and data onto the bus 702. The bus 702 carries the information to the memory 706 from which the processor 704 retrieves and executes the instructions using some of the data sent with the instructions. The instructions and data received in the memory 706 may optionally be stored on the storage device 708, either before or after execution by the processor 704.

While certain embodiments of the invention are described above, and FIGS. 1-7 disclose the best mode for practicing the various inventive aspects, it should be understood that the invention can be embodied and configured in many different ways without departing from the spirit and scope of the disclosure.

For example, embodiments are disclosed above in the context of facilitating a purchase of an item. Embodiments, as disclosed above, are directed to systems and methods to facilitate sale and purchase of items at discounted prices to an end-user. Specifically, one or more delivery devices, such as discount cards or coupons, are generated and distributed to the end-users to increase usage or sale of an item. End-users are also enabled to access information regarding the purchase of various items by a single registration step. Further, end-users can purchase items at discounted prices in the absence of prior history of transactions from any or a combination of the sellers, the facility providers, and/or the distribution entities.

Embodiments, as disclosed above, are directed to systems and methods to provide profit for the seller of the item, the provider of the delivery device and/or the distributor of the delivery device based on an unused discount value present on the delivery device.

Embodiments, as disclosed above, are directed toward a single platform for multiple sellers to offer the sale of multiple items and for the end-users to make one or more purchases from the sellers.

In some embodiments, the stored value on the delivery device can be replenished or recharged when the stored value falls below a minimum threshold value or is null. The stored value can be recharged through additional purchases or through various reward programs offered by the facility providers, the distribution entities and/or the sellers.

In other embodiments, the delivery device may be a physical card or any portable device that includes a magnetic strip, a biometric chip, an RFID (Radio Frequency Identification) tag, or other types of Near Field Communication (NFC) chip, for enabling unique identification of the delivery device and facilitating transactions at various points-of-sale terminals.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method comprising:
providing an application on a user device to enable an end-user to register a coded delivery device, wherein the delivery device is associated with a total discount value and at least one distribution entity;
generating, by the application, a personalized user interface, wherein the personalized user interface displays the total remaining discount value to the end-user;
receiving, by a server, a request from the application via the user interface, over a network, wherein the request is indicative of a purchase of at least one item from a seller, the at least one item having a wholesale price and a listed price greater than the wholesale price;
dynamically determining, by the server, a first value that is equal to the difference between the listed price and the wholesale price multiplied by predetermined distribution ratios corresponding to the discount value, the seller, and the at least one distribution entity;
determining, by the server, a discounted price for the at least one item that is equal to the first value multiplied by the distribution ratio corresponding to the discount value, which discounted price is less than the listed price and wherein the difference between the listed price and the discounted price is the discount value;
enabling, through the application, the end-user to purchase the at least one item at the discounted price;
updating, by the server, the total discount value associated with the delivery device based on a difference between the listed price and the discounted price, wherein the updated remaining discount value is displayed through the personalized user interface; and
determining, by the server, an additional value, wherein each said additional value is transferred to one of an account of the seller, an account of at least one said distribution entity.

2. The method of claim 1, wherein the at least one item is a product or a service.

3. The method of claim 1, wherein the discount value is stored in the form of a currency denomination on the delivery device.

4. The method of claim 1, wherein the delivery device includes one of a card, a coupon, and a virtual device including one of a digital number, QR code, and Bar Code.

5. The method of claim 1, further comprising:
assigning, by the server, a unique identification number and the total discount value to the delivery device;
storing, by the server, the unique identification number, the total discount value, and the remaining discount value in a database; and
associating, by the server, said at least one distribution entity with the delivery device using the unique identification number.

6. The method of claim 1, further comprising:
receiving, by the server, registration details from the application via the user device over a network, wherein the registration details comprise the unique identification number as well as registrant information used to determine identity of said user as a registrant; and
activating, by the server, the delivery device upon registration by the end-user.

7. The method of claim 1, further comprising:
receiving, by the application, a query from the end-user via the user interface to search for an item for purchase; and
displaying, by the application, through the personalized user interface, a list of items from a plurality of sellers based on the query.

8. The method of claim 1, further comprising;
receiving, by the server, account details of the at least one distribution entity, over the network; and
storing, by the server, the account details of at least one distribution entity, in a database.

9. The method of claim 1, further comprising;
storing, by the server, a plurality of distribution ratios for a plurality of pairs of sellers and distribution entities in a database; and
determining, by the server, the distribution ratio corresponding to the seller, the at least one distribution entity, from the database.

10. A method comprising:
providing an application on a user device to enable an end-user to register a delivery device, wherein the delivery device is associated with a discount value and at least one distribution entity;
receiving, by the server, registration details from the user device over a network, wherein the registration details comprise the unique identification number, and wherein the delivery device is activated upon registration by the end-user;
generating, by the application, a personalized user interface, wherein the personalized user interface displays the discount value to the end-user;
receiving, by a server, a request from the user device over a network, wherein the request is indicative of a purchase of at least one item from a seller, the at least one item having a wholesale price and a listed price greater than the wholesale price;
determining, by the server, a discounted price for the at least one item, wherein the discounted price is lesser than the listed price, and wherein the difference between the listed price and the discounted price is less than or equal to the discount value;
enabling, through the application, the end-user to purchase the at least one item at the discounted price;
updating, by the server, the discount value associated with the delivery device based on a difference between the listed price and the discounted price, wherein the updated discount value is displayed through the personalized user interface; and
determining, by the server, a first value and a second value based on a difference between the discounted price and the wholesale price, and a distribution ratio corresponding to the seller and the at least one distribution entity, wherein a sum of the first value and the second value is equal to the difference between the discounted price and the wholesale price, and wherein when the first value is greater than zero is transferred to an account of the at least one distribution entity and wherein when the second value is greater than zero is transferred to an account of the seller.

11. The method of claim 10, wherein the at least one item is a product or a service.

12. The method of claim 10, wherein the discount value is stored in the form of a currency denomination on the delivery device.

13. The method of claim 10, wherein the delivery device includes one of a card, a coupon, and a virtual device including one of a digital number, QR code, and Bar Code.

14. The method of claim 10, further comprising:
assigning, by the server, the unique identification number and the discount value to the delivery device;
storing, by the server, the unique identification number and the discount value in a database; and
associating, by the server, the at least one distribution entity with the delivery device using the unique identification number.

14. The method of claim 10, further comprising:
receiving, by the application, a query from the end-user to search for an item for purchase; and
displaying, through the personalized user interface, a list of items from a plurality of sellers based on the query.

15. The method of claim 10, further comprising;
receiving, by the server, account details of the at least one distribution entity over the network; and
storing, by the server, the account details of at least one distribution entity in a database.

16. The method of claim 10, further comprising;
storing, by the server, a plurality of distribution ratios for a plurality of pairs of sellers and distribution entities in a database; and
determining, by the server, the distribution ratio corresponding to the seller and the at least one distribution entity from the database.

17. A system comprising:
a user device comprising an application installed thereon, wherein the application is configured to:
enable an end-user to register a delivery device, wherein the delivery device is associated with a discount value and at least one distribution entity; and
display, through a personalized user interface, the discount value to the end-user; and
a server disposed in communication with the user device over a network, wherein the server is configured to:
receive a request from the user device over a network, wherein the request is indicative of a purchase of at least one item from a seller, the at least one item having a wholesale price and a listed price greater than the wholesale price;
enable, through the application, the end-user to purchase the at least one item at a discounted price, wherein the discounted price is lesser than the listed price, and wherein the difference between the listed price and the discounted price is less than or equal to the discount value;
update, by the server, the discount value associated with the delivery device based on a difference between the listed price and the discounted price, wherein the updated discount value is displayed through the personalized user interface; and
determine a first value and a second value based on a difference between the discounted price and the wholesale price, and a distribution ratio corresponding to the seller and the at least one distribution entity, wherein a sum of the first value and the second value is equal to the difference between the discounted price and the wholesale price, and wherein when the first value is greater than zero is transferred to an account of the at least one distribution entity and when the second value is greater than zero is transferred to an account of the seller.

18. The system of claim 17, wherein the at least one item is a product or a service.

19. The system of claim 17, wherein the delivery device includes one of a card, a coupon, and a virtual device including one of a digital number, QR code, and Bar Code.
